(19) United States
(12) Patent Application Publication
(10) Pub. No.: US 2003/0018728 A1
(43) Pub. Date: Jan. 23, 2003

(54) Data communication apparatus between plural bases and method therefor

(76) Inventors: Yukinari Kaneta, Kanagawa (JP); Kazumasa Higuchi, Kanagawa (JP)

Correspondence Address: ROBIN BLECKER & DALEY, 2ND FLOOR, 330 MADISON AVENUE, NEW YORK, NY, 10017, US

(21) Appl. No.: 10/194,094

(22) Filed: Jul. 11, 2002

(30) Foreign Application Priority Data
Jul. 17, 2001 (JP) 217271/2001
Jun. 21, 2002 (JP) 181042/2002

(51) Int. Cl. G06F 15/16

(52) U.S. Cl. 709/206; 709/215

(57) ABSTRACT

A communication apparatus according to the present invention is connected with other centers through a network, and the apparatus includes one or a plurality of center boxes addressed to the other centers, and one or a plurality of local boxes addressed to the locals connected to the center itself. The present communication apparatus stores data addressed to another center and data addressed to a local connected to the other center from a local connected to the apparatus itself into its center box addressed to the other center, and the apparatus stores data addressed to a local connected to the apparatus itself, the data having been transmitted from another center, into its local box addressed to the local.

### BACKGROUND OF THE INVENTION

1. Field of the Invention

The present invention relates to a communication technology, and more particularly to data communication between plural bases.

2. Description of Related Art

Generally, data communication is frequently performed between branch offices of the same company or between affiliate companies. In particular, as for account settlement data and purchase data, it is necessary to communicate necessary data by a closing day in every month.

Conventionally, transmission and reception of data are individually performed between each base.

However, it makes communication efficiency worse to communicate individually between each branch office or between each affiliate company.

### SUMMARY OF THE INVENTION

An object of the present invention is to perform a data communication between plural bases.

A communication system of the present invention is a communication system including a plurality of centers and locals connected to respective centers, wherein each of the centers includes: one or a plurality of center boxes addressed to other centers; one or a plurality of local boxes addressed to locals connected to the center itself; center box storing means for storing data addressed to another center and data addressed to a local connected to the other center into a center box addressed to the other center; and local box storing means for storing data addressed to a local connected to the center itself, the data having been transmitted from another center, into a local box addressed to the local, and wherein each of the local includes: transmission means for transmitting data addressed to another center or another local to a center to which the local itself is connected; and reception means for receiving data addressed to the local itself from a local box addressed to the local itself in the center to which the local itself is connected.

Moreover, a communication apparatus of the present invention is a communication apparatus for a center connected with other centers through a network and connected with a plurality of locals, the apparatus comprising: one or a plurality of center boxes addressed to the other centers; one or a plurality of local boxes addressed to the locals connected to the center itself; center box storing means for storing data addressed to another center and data addressed to a local connected to the other center into a center box addressed to the other center; and local box storing means for storing data addressed to a local connected to the center itself, the data having been transmitted from another center, into a local box addressed to the local.

Moreover, a communication method of the present invention is a communication method of a center connected with other centers through a network and connected with a plurality of locals, the method comprising: a reception step of receiving data from another center or another local; a center box storing step of storing data addressed to another center and data addressed to a local connected to the other center into a center box addressed to the other center; and a local box storing step of storing data addressed to a local connected to the center itself, the data having been transmitted from another center, into a local box addressed to the local.

### BRIEF DESCRIPTION OF THE DRAWINGS

FIG. 1 is a conceptual diagram showing the configuration of a communication system according to an embodiment of the present invention;

FIG. 2 is a diagram showing network connection between centers, a local base, a user and a manager;

FIG. 3 is a diagram showing a master file;

FIG. 4 is a diagram showing a format of a header and a trailer in a standard mode;

FIG. 5 is a diagram showing a format of a header and a trailer in a Mark 3 mode;

FIG. 6 is a diagram showing the hardware configuration of a center, a local base and the like;

FIG. 7 is a diagram showing a file including a plurality of destinations; and

FIG. 8 is a diagram showing flows of information (or data).

### DETAILED DESCRIPTION OF THE PREFERRED EMBODIMENTS

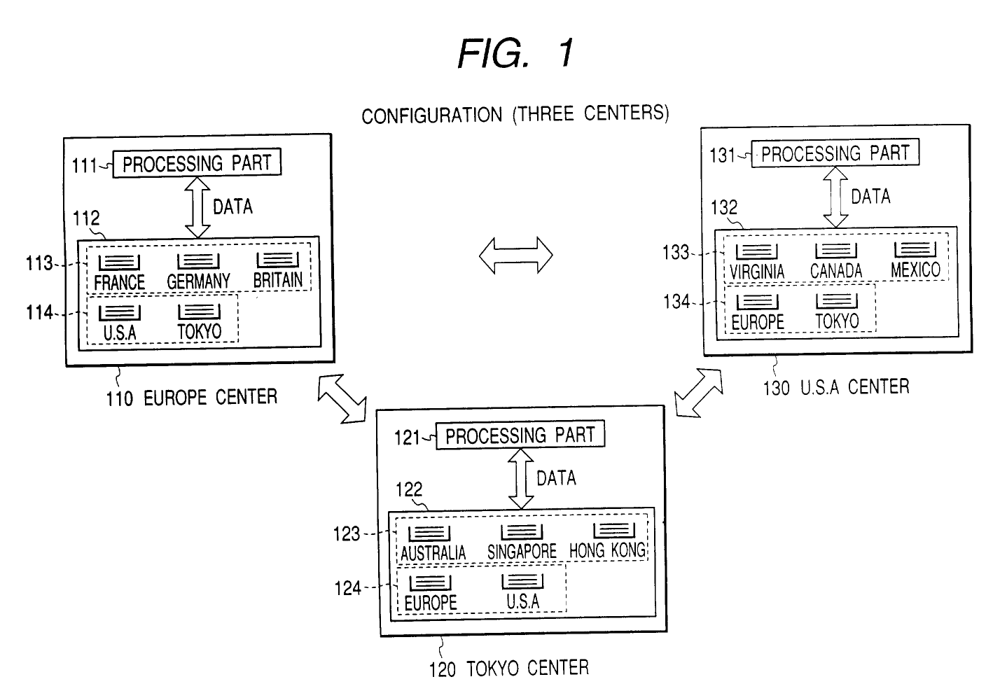

FIG. 1 is a conceptual diagram showing the configuration of a communication system according to an embodiment of the present invention.

In FIG. 1, the present communication system includes an Europe center 110, a Tokyo center 120, a USA center 130 and a plurality of bases connected to each center.

The Europe center 110, the Tokyo center 120 and the USA center 130 severally compresses data to transmit the compressed data automatically to each other through networks by Connect Direct. Connect Direct can automatically retransmit data if a communication error happens.

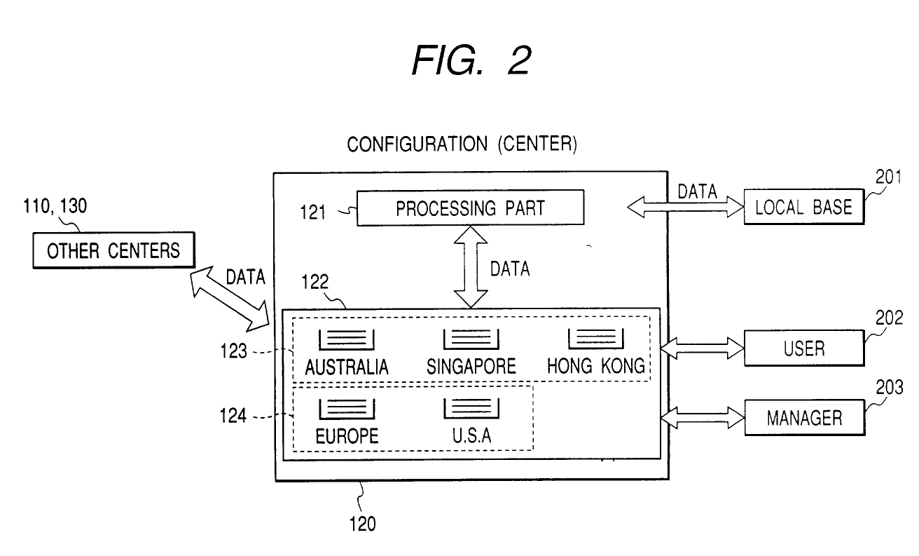

As shown in FIG. 2, one or a plurality of local bases 201 is connected with the Tokyo center 120. Branch offices, affiliate companies or the like such as an Australia base, a Singapore base, a Hong Kong base or the like are connected with the Tokyo center 120 as the local bases 201.

The Tokyo center 120 includes a processing part 121 and a mailbox 122. The mailbox 122 is composed of a local mailbox 123 and a center mailbox 124.

The local mailbox 123 is composed of a mailbox addressed to Australia, a mailbox addressed to Singapore, and a mailbox addressed to Hong Kong correspondingly to the local bases 201.

The center mailbox 124 is composed of a mailbox addressed to the Europe center 110, and a mailbox addressed to the USA center 130 correspondingly to the other centers 110 and 130.

In FIG. 1, the Europe center 110 includes a processing part 111 and a mailbox 112 similarly. The mailbox 112 has a local mailbox 113 and a center mailbox 114. The local mailbox 113 is composed of a mailbox addressed to France, a mailbox addressed to Germany, and a mailbox addressed to Britain. Correspondingly to the mail boxes, a France base, a Germany base, and a Britain base are connected with the Europe center 110 as local bases. The center mailbox 114 has a mailbox addressed to the USA center 130, and a mailbox addressed to the Tokyo center 120.

Similarly, the USA center 130 includes a processing part 131 and a mailbox 132. The mailbox 132 has a local mailbox 133 and a center mailbox 134. The local mailbox 133 has a mailbox addressed to Virginia, a mailbox addressed to Canada, and a mailbox addressed to Mexico. Correspondingly to the mail boxes, a Virginia base, a Canada base, and a Mexico base are connected with the USA center 130 as local bases. The center mailbox 134 has a mailbox addressed to the Europe center 110, and a mailbox addressed to the Tokyo center 120.

Next, a communication method in the present embodiment is described.

A description is given to the communication from a certain local base to another local base.

First, the case where communication is performed between two local bases connected with the same center is described. For example, it is the case where communication is performed from the Australia base to the Singapore base, both being connected with the Tokyo center 120.

The Australia base transmits a file having a destination to the Singapore base to the Tokyo center 120.

In the Tokyo center 120, the processing part 121 receives the file, and assorts the file correspondingly to the destination to store the file into a corresponding mail box 123. In this case, the processing part 121 stores the received file to the mailbox 123 addressed to Singapore.

After that, the Singapore base accesses the Tokyo center 120, and can receive the file from the mailbox 123 addressed to Singapore. At this juncture, when the Tokyo center 120 has received the file having the destination to the Singapore base, the Tokyo center 120 may automatically transmit the file to the Singapore base as a post-processing of the reception. The Singapore base can perform the setting of the post-processing by accessing the Tokyo center 120.

Next, the case where communication is performed between two local bases connected different centers is described. For example, it is the case where the communication is performed from the Australia base connected with the Tokyo center 120 to the France base connected with the Europe center 110.

The Australia base transmits a file having the destination to the France base to the Tokyo center 120. In the Tokyo center 120, the processing part 121 receives the file, and assorts the file correspondingly to the destination of the file to store the file into a corresponding mail box 124 of the center to which the local based is connected. In this case, because the France base is connected with the Europe center 110, the processing part 121 stores the received file to the mailbox 124 addressed to the Europe center.

The Tokyo center 120 transmits the file in the mailbox 124 addressed to the Europe center 110 to the Europe center 110. When the processing part 111 of the Europe center 110 receives the file, the processing part 111 assorts the file correspondingly to the destination to store the file into a corresponding local mailbox 113. In this case, the processing part 111 stores the received file to the mailbox 113 addressed to France.

After that, the France base accesses the Europe center 110, and can receive the file from the mailbox 113 addressed to France itself. Moreover, the Europe center 110 may automatically transmit the file to the France base.

The local base 201 in FIG. 2 is described. The local base 201 can use various platforms. Moreover, when the local base 201 performs communication with the center 120 or the like, the local base 201 can select a communication protocol. For example, the local base 201 can select File Transfer Protocol (FTP) or Connect Direct. FTP does not need compression, and has no automatic retransmission function at the time of a communication error. Consequently, FTP is recommended in the case where the situations of lines are in good conditions. Connect Direct uses compression and has an automatic retransmission function at the time of a communication error. Consequently, Connect Direct is recommended in the case where the situations of lines are not in good conditions. Moreover, the local base 201 can select a standard mode, a Mark 3 mode and a free mode as its file transfer mode.

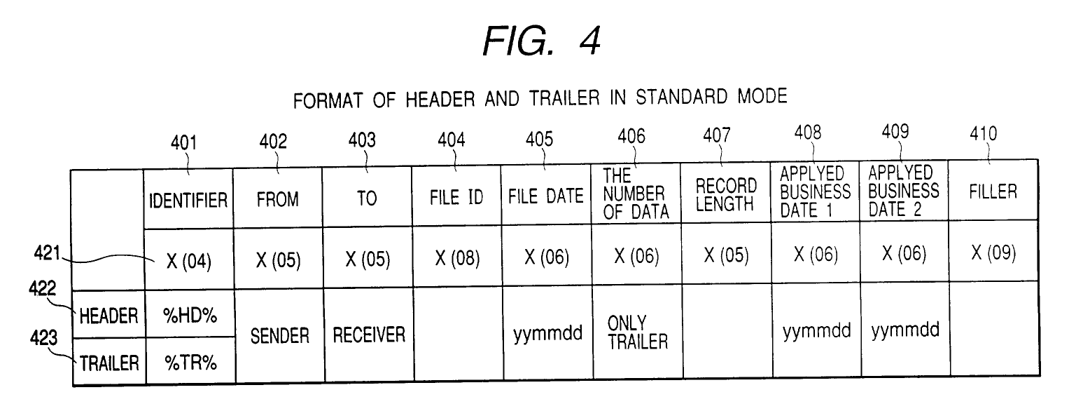

FIG. 4 shows a header and a trailer in the standard mode. The header 422 is attached at the head of a file, and the trailer 423 is attached at the end of the file. “% HD %” is given as an identifier 401 indicating the header 422, and “% TR %” is given as an identifier 401 indicating the trailer 423. The header 422 and the trailer 423 are furthermore provided with a sender 402, a receiver 403, a file ID 404, a file date 405, a number of data (a number of records) 406, a record length 407, a first applied business date 408, a second applied business date 409, and a filler (an option area) 410. A row 421 shows the numbers of bytes of these items.

Incidentally, because account settlement data and purchase data need to communicate their necessary data by a closing day in every month, the file date 404 or the applied business dates 408 and 409 can be set arbitrarily at a local base correspondingly to the closing day.

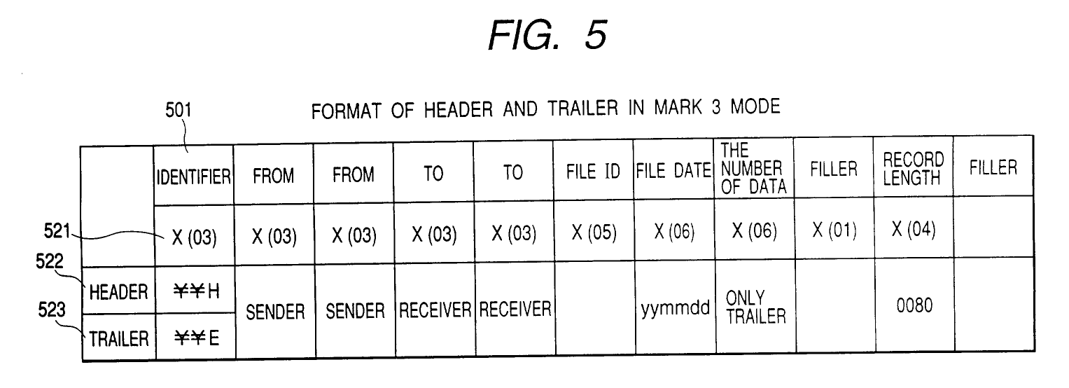

FIG. 5 shows a format of a header and a trailer in the Mark 3 mode. The contents of the header 522 and the trailer 523 are the same as those in the standard mode, but the order, the size 521 and the like of each item are different from those in the standard mode. “¥¥H” is given as an identifier 501 indicating the header 522, and “¥¥E” is given as an identifier 501 indicating the trailer 523.

The rest free mode has no header and trailer, and their information is described as a file name. By reading the file name, the processing part 121 acquires the same information as the contents described in the header of the standard mode or the Mark 3 mode.

When the local base 201 performs transmission or reception to the center 120 or the like, the local base 201 inputs a base code or a password to access the center 120 or the like. The local base 201 can receive only the files in the mailbox 123 addressed to the local base 201 itself. By the use of the base code and the password, it is possible to prevent the leakage of information of each local base 201.

Next, a user 202 in FIG. 2 is described. The user 202 is a computer of one or a plurality of persons in charge belonging to the local base 201. The user 202 can access the center 120 or the like by the use of a Web browser to inquire about the communication information of data or the information of communication data.

To put it concretely, the user 202 can inquire about the results of transmission and reception, a transmission base, a reception base, a file ID, a record length, the number of the bytes of a file, a file date, a status code (a communication situation), an error code, a file transfer mode (the standard mode, the Mark 3 mode, or the free mode), and the like. The center 120 or the like processes these pieces of information to store, and the center 120 or the like can supply the information to the user 202.

At this time, the user 202 accesses the center 120 or the like by inputting its user ID and its password. Moreover, the user 202 can inquire only about the information of files in the local base 201 to which the user 202 belongs, and cannot inquire the information of files in the other local bases 201. By the use of the user ID and the password, the leakage of the information of each local base 201 can be prevented.

Moreover, the user 202 can perform the narrowing of display items by retrieval, and the sort of a file size, a file name or the like, and thereby can display the above-mentioned information on a screen.

Next, the center 120 or the like is described. The center 120 or the like performs the sort processing of received files by destinations in accordance with the standard mode, the Mark 3 mode or the free mode, and stores the sorted files into the corresponding mailbox 123 or 124. Moreover, the center 120 or the like performs the transformation of character codes of the received files such as EBCDIC, ASCII, PACK, ZONE and the like. The character code is determined by the platform used in each local base 201. That is, there is a case where the character code used by each local base 201 differs from each other according to the platform. Accordingly, the center 120 or the like memorizes the character code used by each local base 201, and the center 120 or the like transforms the received file into the character code according to each local base 201 to store the transformed file into the mailbox 123. Moreover, for making it possible to treat data the character code of which the user does not want to change, conditions for nontransformation can be set in the operation of the processing part 121.

When the center 120 or the like receives a file, the center 120 or the like can start the post-procedure thereof. For example, when the center 120 or the like receives a file addressed to a predetermined local base 201, the center 120 or the like can automatically transmit the file to the local base 201. Moreover, if an communication error occurs at that time, the center 120 or the like can automatically transmit an electronic mail telling the fact. The destination of the electric mail is an electric mail address of a person in charge belonging to the local base 201. The electrical mail address is stored by the center 120 or the like.

A file ID can be stored in a header and a trailer as shown in FIGS. 4 and 5. When the center 120 or the like has received a plurality of files having the same file ID a day, the center 120 or the like overwrites an old one by a new one by considering them as the same file. Incidentally, there is a case where some local base is required to store the files having the same file ID in a mailbox separately as different files. In that case, the local base 201 or the user 202 accesses the center 120 or the like to set a flag by plural times, and thereby it becomes possible to perform the above-mentioned processing.

If the local base 201 fetched a file from the mailbox 123, the center 120 or the like deletes the file after, for example, ten days from the fetching. If the local base 201 wants to re-receive the received file owing to the disappearance of the file, the local base 201 can re-receive the disappeared file as long as it is within ten days by accessing the center 120 or the like to set a re-reception flag.

When the local base 201 receives a file from the center 120 or the like, the local base 201 can receive the file by one of the methods of batch reception, date-specified reception, re-reception, a plurality of times of reception per day, and automatic reception.

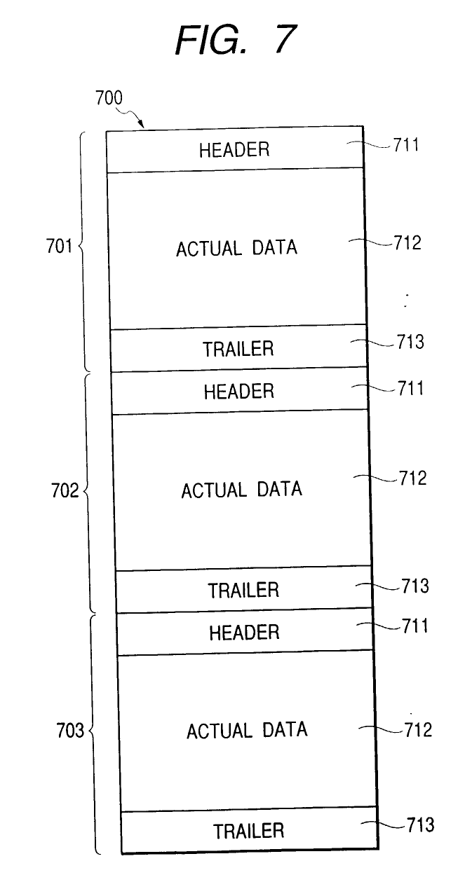

As shown in FIG. 7, each local base 201 can transmit a file 700 in which data 701, 702 and 703 with a plurality of destinations are included. Although three data 701, to 703 should essentially be transmitted individually as different files, a plurality of data 701 to 703 can be transmitted by one time as one file according to the method. Each of the data 701 to 703 may have a destination to a different local base. The data 701 to 703 includes a header 711, actual data 712 and a trailer 713 severally. The header 711 and the trailer 713 severally have one of the formats shown in FIG. 4 or 5, and consequently the header 711 and the trailer 713 can describe a receiver (or a destination), a file ID and the like to each of the data 701 to 703.

When the center 120 or the like receives the data 701 to 703 including a plurality of file ID's, a plurality of destinations, or a plurality of dates as one file 700, the center 120 or the like classifies the data 701 to 703 to store them into the mailboxes in the center mailbox 124 or the local mailbox 123 correspondingly to the destinations.

The processing after that is the same as that described above. Because the local base 201 is required to transmit the plural data 701 to 703 only once as one file 700, the transmission can be performed by a simple procedure.

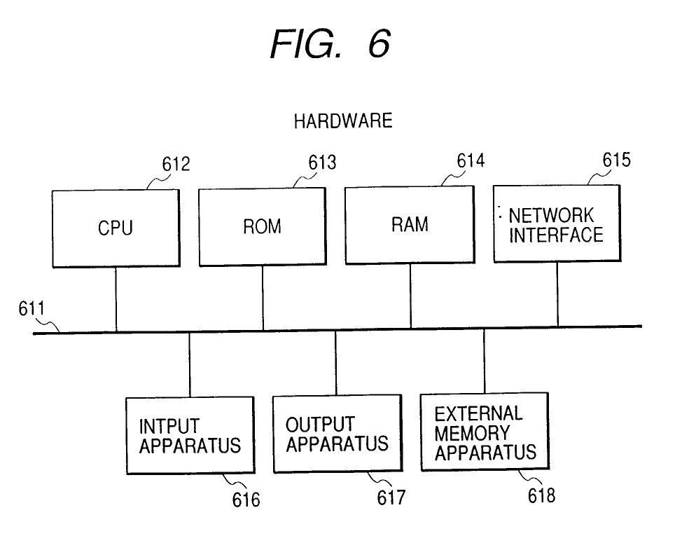

FIG. 6 shows the configuration of the center 120 or the like, the local base 201, the user 202 and a manager 203. These are, for example, a general purpose computer, a personal computer, or the like. A central processing unit (CPU) 612, a ROM 613, a RAM 614, a network inter face 615, an input apparatus 616, an output apparatus 617 and an external memory apparatus 618 are connected to a bus 611.

The CPU 612 executes the processing or the operations of data, and furthermore controls the connected various components through the bus 611. The CPU 612 executes the processing described above.

Control procedures of the CPU 612 (or computer programs) are previously stored in the ROM 613, and the system is started by the execution of the computer program by the CPU 612. Computer programs are stored in the external memory apparatus 618, and the computer programs are copied to the RAM 614 to be executed. The RAM 614 is used as a working memory for the inputting and the outputting of data and the transmission and the reception of data, and used as a temporary memory for the control of each component.

The network interface 615 is an interface for the connection with a network. The input apparatus 616 is, for example, a keyboard, a mouse or the like, and can perform various pieces of designation, input, and the like. The output apparatus 617 is a display and a printer, and can display or print communication information.

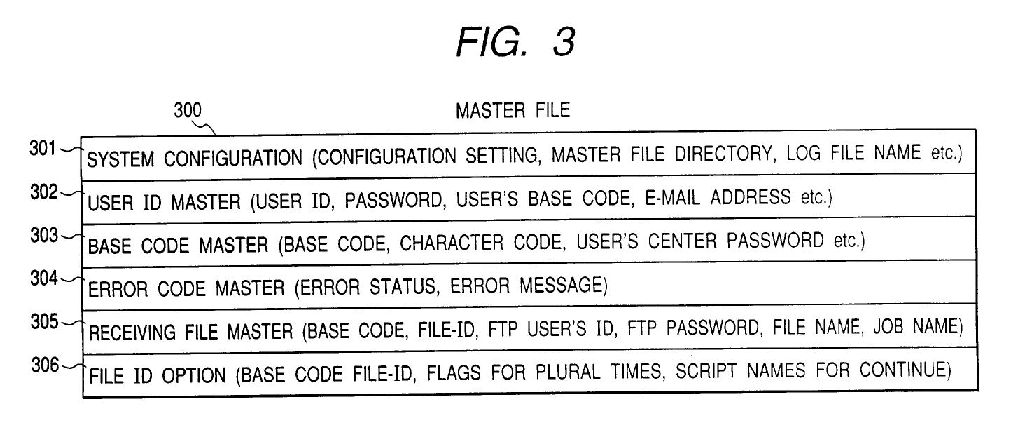

The external memory apparatus 618 is, for example, a hard disk storage unit, a CD-ROM or the like, and the contents stored therein are not erased even if the power thereof is turned off. The center 120 or the like stores a master file 300 shown in FIG. 3 in the external memory apparatus 618 as well as the above-mentioned computer program.

FIG. 3 shows the master file 300 which each of the centers 110, 120 and 130 stores. The master file 300 includes a system configuration 301, a user ID master 302, a base code master 303, an error code master 304, a receiving file master 305, and a file ID option 306.

The system configuration 301 stores configuration setting, a master file directory, a log file name and the like. The user ID master stores a user ID, a password, a user's base code, a mail address and the like. The base code master 303 stores a base code, a character code, a user's center, a password and the like. The error code master 304 stores an error status, an error message and the like. The receiving file master 305 stores a base code, a file ID, a File Transfer Protocol (FTP) user's ID, an FTP password, a file name, a JOB name and the like. The file ID option 306 stores a base code, a file ID, a flag for plural times, a script name for continue, and the like.

The center 120 or the like performs the above-mentioned processing on the basis of the master file 300. The manager 203 shown in FIG. 2 is a computer of a manager performing the maintenance of the center 120 or the like, and the manager 203 is connected with the center 120 or the like. The manager 203 performs the maintenance of the master file 300 of FIG. 3 and the like. Moreover, the local base 201 and the user 202 can set and change predetermined items in the master file 300 within their own authority.

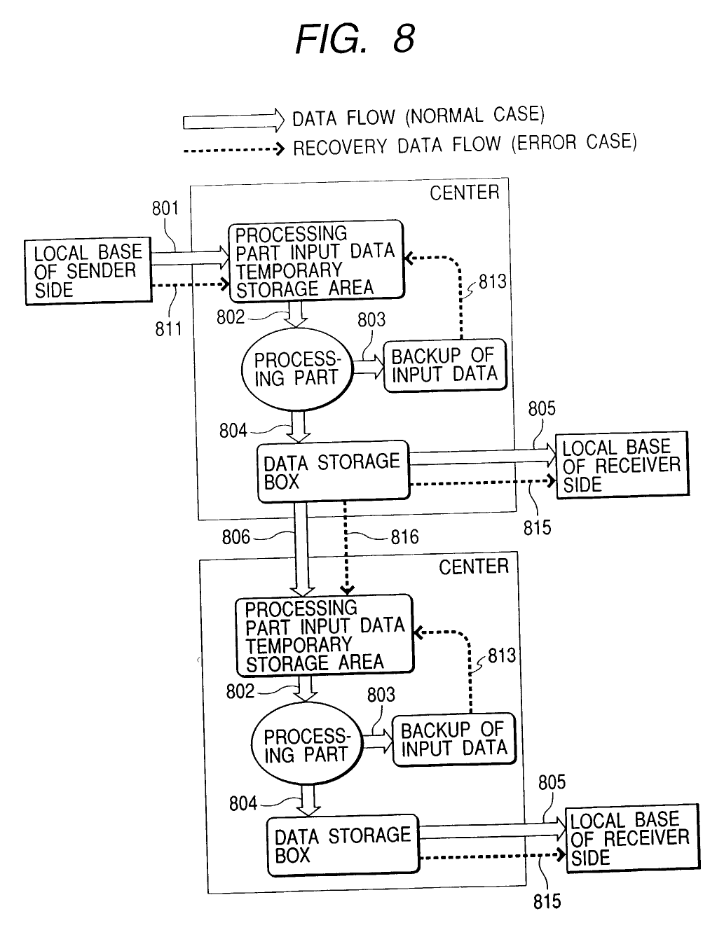

FIG. 8 is a diagram showing a data flow in a normal case and a data flow in a recovery case. The data flow in a normal case is like that described on FIGS. 1 and 2. In the case where the transmission from a local base of sender side failed in the data flows, the data are re-transmitted (re-transmission 811) to be recovered. Next, in the case where the processing part failed to perform the processing such as data translation or the like, the recovery of the data can be achieved by re-submitting the data to a processing part input data temporary storage area (re-submission 820).

Next, in the case where a local base on the receiver side lost data in the local base after the local base had received the data, the recovery of the data can be achieved by re-receiving the data (re-reception 815) as long as it is within a center holding period of time. Next, in the transmission between centers, even if a communication error occurs, the data are automatically re-transmitted by a function of Connect Direct (automatic re-transmission 816). As described above, recoveries are achieved at each position to prevent the disappearance of data.

The present embodiment is realized by the computer's execution of a program. Moreover, the present invention can be applied to means for supplying a program to a computer, for example, a recording medium such as a CD-ROM, in which such a program is recorded, or a transmission medium such as the Internet, by which such a program is transmitted, as an embodiment of the present invention. The program, the recording medium and the transmission medium are included in the scope of the present invention. As the recording medium, for example, a flexible disk, a hard disk, an optical disk, a magneto-optical disk, a CD-ROM, a magnetic tape, a non-volatile memory card, a ROM and the like can be used.

As described above, in the communication system according to the present embodiment, the plural centers 120 and the like are connected to each other through a network, and one or a plurality of local bases 201 is connected with each of the center 120 or the like. A local base transmits data addressed to another local base to the center to which the local base is connected. The center receives the data from the local base. The center stores the data addressed to a local base connected with the center itself into a local mailbox addressed to the local base corresponding to the destination of the data, and the center stores the data addressed to a local base connected with another center into a center mailbox addressed to the other center. The center transmits the data in the center mailbox to the corresponding other center. The other center stores the received data in a corresponding local mailbox. The local base can fetch the data from the local mailbox in the other center. Thereby, effective communication can be performed.

In particular, because data communication is frequently performed between branch offices of the same company or between affiliate companies, the improvement of communication efficiency remarkably appears according to the present embodiment in comparison with the case where communication is performed individually between each branch office or between each affiliate company. Moreover, by setting a plurality of centers by regional groups according to the situation of physical line paths constituting a network, the duplication of network traffics can be decreased, and furthermore, the simplification of network security management can be achieved in comparison with the case where communication is performed individually. Moreover, by setting of the centers by regional groups, the system in which a center manager performs the support of local bases following the center can be employed, and consequently a merit in which it is easy to brake the barriers of a time difference and languages can be obtained.

Incidentally, any of the above-mentioned embodiments is only an example of the concretization at the time of the implementation of the present invention, and accordingly the scope of the present invention should not be interpreted to be limited by the embodiments. That is, the present invention can be implemented in various forms without departing from the sprit or the principal features of the invention.

As described above, according to the present invention, a plurality of centers are set to be connected with locals. The center stores the data addressed to a local connected with a center itself into its local mailbox, and the center stores the data addressed to a local connected with another center into its center mailbox addressed to the other center. Thereby, effective communication can be performed.

What is claimed is:

1. A communication system including centers and locals connected to respective centers, wherein each of the centers includes:
one or a plurality of center boxes addressed to other centers;
one or a plurality of local boxes addressed to locals connected to said center itself;
center box storing means for storing data addressed to another center and data addressed to a local connected to said other center into a center box addressed to said other center; and
local box storing means for storing data addressed to a local connected to said center itself, the data being transmitted from another center, into a local box addressed to said local, and
wherein each of said local includes:
transmission means for transmitting data addressed to another center or another local to a center to which said local itself is connected; and
reception means for receiving data addressed to said local itself from a local box addressed to said local itself in said center to which said local itself is connected.

2. A communication system according to claim 1, wherein each of the centers further comprising:
reception means for receiving data from another center or another local; and
transmission means for transmitting data stored in a center box to another center corresponding to said center box.

3. A communication system according to claim 1, wherein, when each of said centers receives a plurality of data, a plurality of addresses or a plurality of dates as one file, said center classifies the received data, the received addresses or the received dates to store them into a center box or a local box corresponding to the data, the addresses or the dates.

4. A communication system according to claim 1, wherein transmission means of said center automatically re-transmits data in case of a communication error.

5. A communication system according to claim 4, wherein said transmission means of said center performs data transmission by Connect Direct.

6. A communication system according to claim 4, wherein said transmission means and said reception means of said local can select a communication protocol to perform communication.

7. A communication system according to claim 6, wherein said transmission means and said reception means of said local can select at least Correct Direct or FTP to perform communication.

8. A communication system according to claim 1, wherein said center includes means for supplying communication information of data or information of communication data in response to a request from an outside.

9. A communication system according to claim 2, wherein said center includes means for transforming received data addressed to a local to data by a character code corresponding to said local.

10. A communication apparatus for a center connected with other centers through a network and connected with locals, said apparatus comprising:
one or a plurality of center boxes addressed to said other centers;
one or a plurality of local boxes addressed to said locals connected to said center itself;
center box storing means for storing data addressed to another center and data addressed to a local connected to said other center into a center box addressed to said other center; and
local box storing means for storing data addressed to a local connected to said center itself, the data having been transmitted from another center, into a local box addressed to said local.

11. A communication apparatus according to claim 10, wherein said apparatus further comprising:
reception means for receiving data from another center or another local; and
transmission means for transmitting data stored in a center box to another center corresponding to said center box.

12. A communication apparatus according to claim 10, wherein, when said center box storing means and said local box storing means receive a plurality of data, a plurality of addresses or a plurality of dates as one file, said center box storing means and said local box storing means classify the received data, the received addresses or the received dates to store them into a center box or a local box corresponding to the data, the addresses or the dates.

13. A communication apparatus according to claim 10, wherein transmission means of said apparatus automatically re-transmits data in case of a communication error.

14. A communication apparatus according to claim 13, wherein said transmission means of said center performs data transmission by Connect Direct.

15. A communication apparatus according to claim 10, said apparatus further comprising means for supplying communication information of data or information of communication data in response to a request from an outside.

16. A communication apparatus according to claim 11, said apparatus further comprising means for transforming received data addressed to a local to data by a character code corresponding to said local.

17. A communication method of a center connected with other centers through a network and connected with locals, said method comprising:
a reception step of receiving data from another center or another local;
a center box storing step of storing data addressed to another center and data addressed to a local connected to said other center into a center box addressed to said other center; and
a local box storing step of storing data addressed to a local connected to said center itself, the data having been transmitted from another center, into a local box addressed to said local.

18. A recording medium capable of being read by a computer, said medium recording a program of communication performed by a center connected with other centers through a network and connected with a plurality of locals, said program making said computer execute procedures comprising:
a reception procedure of receiving data from another center or another local;
a center box storing procedure of storing data addressed to another center and data addressed to a local connected to said other center into a center box addressed to said other center; and
a local box storing procedure of storing data addressed to a local connected to said center itself, the data having been transmitted from another center, into a local box addressed to said local.
